(19) United States
(12) Patent Application Publication
(10) Pub. No.: US 2005/0096935 A1
(43) Pub. Date: May 5, 2005

(54) Remote development support system and method

(75) Inventors: Lev M. Bolotin, Kirkland, WA (US); George Leland Anderson, Redmond, WA (US); Robert Paul Huber, Sammamish, WA (US); Roland Schuler, Wangen (DE)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: Data I/O Corporation, Redmond, WA (US)

(21) Appl. No.: 10/971,610

(22) Filed: Oct. 22, 2004

Related U.S. Application Data
(60) Provisional application No. 60/517,263, filed on Nov. 3, 2003.

(51) Int. Cl. G06F 17/30; G06F 17/60; G06F 7/00

(52) U.S. Cl. 705/1; 707/1

(57) ABSTRACT

A system and method for remote support of product development includes a developer environment at a first geographic location, a support environment at a second geographic location, and a communication channel between the developer environment and the support environment.

### CROSS-REFERENCE TO RELATED APPLICATION(S)

This application claims the benefit of U.S. Provisional Patent Application Ser. No. 60/517,263 filed Nov. 3, 2003, and the subject matter thereof is hereby incorporated herein by reference thereto.

### TECHNICAL FIELD

The present invention relates generally to development and manufacturing systems, and more particularly to a method and apparatus for development and manufacturing at different, remote locations.

### BACKGROUND ART

Modem electronics devices increase in complexity with each new generation. Electronic device development time tends to increase as a function of system complexity. Simultaneously, competitive pressures require shorter development and time to market cycles, making time-to-market a critical success factor in the industry. Product life cycles are also getting shorter. Thus, customers require more complex products, which take more time to develop, but market pressures dictate that the products be developed in shorter and shorter cycles.

In a typical system design, the hardware designers will design a hardware prototype, using the final outline of the system specification and logic design. Software designers will typically write the software to program the hardware. Once the hardware prototype is in place and the software is ready, it is necessary to operate the hardware with the application software.

The earlier that each element is debugged, and the earlier that systems integration and systems-level debugging can be done in the development cycle, the faster the product will get to market. However, if the designer tries to move too quickly, and the product is fixed in final form before all the significant bugs have been removed, it can lead to costly reworking, and loss of customer satisfaction in the market.

Product development does not stop when the design, simulation, real-time emulation, behavior analysis and in-system verification are completed. Instead, the first steps of product deployment usually occur, in which the “final” product is produced, usually in small to moderate quantities, at first, and placed in field tests or market acceptance evaluations.

If the design has been thoroughly verified in the earlier testing phases, it is likely that the “final” versions of the product will function as intended during field test. If not, the product must be debugged and further testing performed. Even if the product works well in field test, the system may require fine-tuning, resulting in hardware design modifications in some cases or software changes in other situations. Thus, if a problem occurs after the product is cast in “final” form, debugging it and then fixing it can be expensive.

Since companies, suppliers, and customers are often geographically and internationally separated, it is difficult to integrate their requirements and efforts in a timely and cost efficient manner. Often duplicate equipment and software are required at different locations and these often require duplicate skills in people or inefficient centralization of skills. Further, normal communications are time consuming for conducting development and manufacturing in globally distant countries in greatly different time zones.

Solutions to these problems have been long sought but prior developments have not taught or suggested any solutions and, thus, solutions to these problems have long eluded those skilled in the art.

### DISCLOSURE OF THE INVENTION

The present invention provides a system and method for remote support of product development including a developer environment at a first geographic location, a support environment at a second geographic location, and a communication channel between the developer environment and the support environment.

The development environment includes tools for designing and testing the product. The support environment includes tools for building the product and assuring quality in the product.

The present invention provides a system and method of connecting customers, a factory, and suppliers in new product development.

Certain embodiments of the invention have other advantages in addition to or in place of those mentioned above. The advantages will become apparent to those skilled in the art from a reading of the following detailed description when taken with reference to the accompanying drawings.

### BRIEF DESCRIPTION OF THE DRAWINGS

FIG. 1 is a block diagram of a development system in accordance with one embodiment of the present invention;

FIG. 2 is a flow diagram of a method of using the development system of FIG. 1;

FIG. 3 is a block diagram of the development system of FIG. 1 in a beta generation mode;

FIG. 4 is a flow diagram of a method of using the development system of FIG. 1 in the beta generation mode;

FIG. 5 is a block diagram of the development system of FIG. 1 in a design release mode; and

FIG. 6 is a flow chart of a method of the present invention.

### BEST MODE FOR CARRYING OUT THE INVENTION

In the following description, numerous specific details are given to provide a thorough understanding of the invention. However, it will be apparent that the invention may be practiced without these specific details. In order to avoid obscuring the present invention, some well-known system configurations and process steps are not disclosed in detail. Likewise, the drawings showing embodiments of the apparatus/device are semi-diagrammatic and not to scale. The same numbers will be used in all the drawing FIGS. to relate to the same elements.

Some portions of the detailed description that follows are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein intended to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities, are merely convenient labels, and are to be interpreted further in view of terms commonly used in the art. Unless specifically stated otherwise as apparent from the following discussions, it is understood that throughout discussions of the present invention, discussions utilizing terms such as “receiving” or “generating” or “utilizing” or “determining” or “outputting” or “transmitting” or “communicating” or “encrypting” or “decrypting” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

The present invention is discussed in terms of developing algorithms for electronic devices, such as NAND technology Flash memory, microcontrollers, serial electrical programmable read-only memories (SEPROMS), and other logic devices. It will be understood by one skilled in the art however that the development system and method of the present invention can be used in the development of other products.

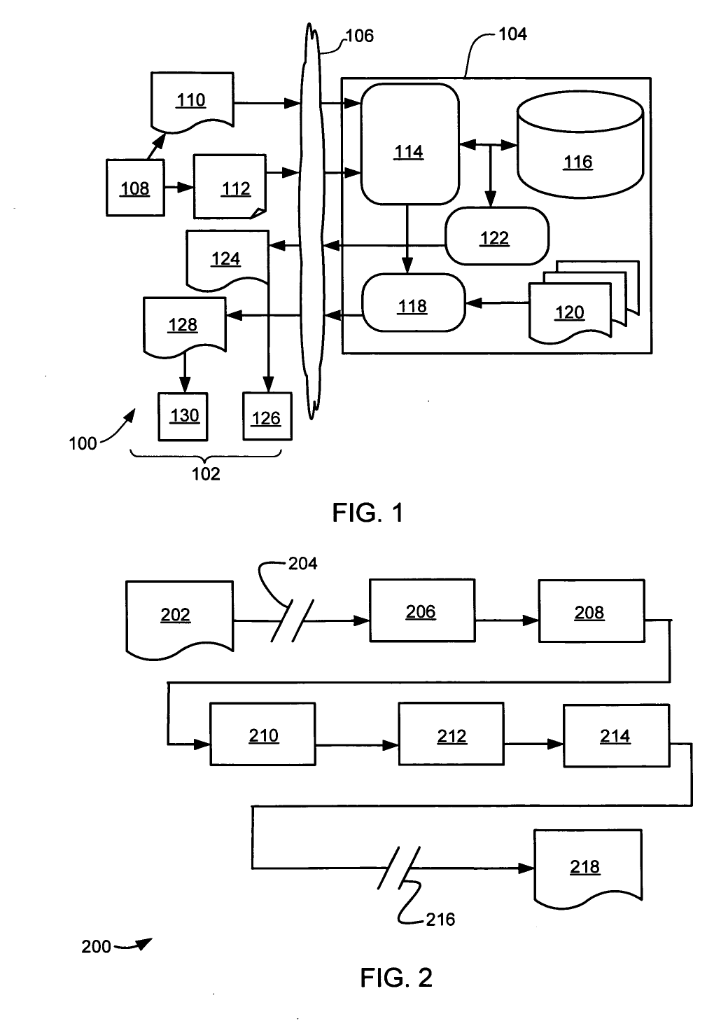

Referring now to FIG. 1, therein is shown a block diagram of a development system 100 in accordance with an embodiment of the present invention. The development system 100 includes a developer environment 102 at a first geographic location connected to a support environment 104 at a second geographic location by a communication channel 106, such as the Internet. The developer environment 102 and the support environment 104 may be physically located around the world from each other in any geographic location that has access to the communication channel 106.

The developer environment 102 includes tools for designing and testing programming algorithms for a product. For example, the developer environment 102 includes a personal computer 108. The personal computer 108 has access to a source of algorithm source files 110 and a source of algorithm support information 112. The developer environment also includes equipment used to create, debug, and implement the programming algorithms. For example, the developer environment 102 may also include a logic analyzer, oscilloscope, probe boards, device programming equipment, and associated adapters and connectors. The developer environment 102 also includes software tools such as a text editor, debugger, Internet browser if the communication channel 106 is the Internet, and a development interface.

Once a developer designs the algorithm to program a specific product, the programming algorithm is transmitted to the support environment 104 via the communication channel 106. The support environment 104 includes tools for building the product and assuring product quality. For example, the support environment 104 includes a development interface 114, such as a web based development interface.

The development interface 114 provides a remotely located developer at the developer environment 102 access to a device support database 116 located in the support environment 104. The device support database 116 has, for example, a library of approved algorithms for a variety of devices. The support environment 104 also includes a build process unit 118 that communicates a result back to the developer environment 102. The build process unit 118 creates a debug algorithm 128 based on the contents of a number of system source files 120 that are accessible by the build process unit 118, and the algorithm source files 110 that are provided through the development interface 114. A job creation unit 122 communicates a number of job files 124 to the developer environment 102 based upon the design criteria supplied through the development interface 114.

The job creation unit 122 transmits the number of job files 124 to the developer environment 102 through the communication channel 106. The number of job files 124 is used to operate a programming unit 126. The programming unit 126 is used to program devices with the debug algorithm 128 developed using the development system 100.

Referring now to FIG. 2, therein is shown a flow diagram of a method 200 of using the development system 100 shown in FIG. 1 to develop an algorithm for programming a device. The developer creates a file, such as a C++ file of an algorithm represented in a file 202. The file 202 is transmitted in a step 204 using the communication channel 106 shown in FIG. 1. The file 202 is received through the development interface 114 on a server in the support environment 104 shown in FIG. 1 in a step 206.

The file 202 is temporarily stored in a queue, for example, constructed as a first in—first out (FIFO) queue, in a step 208. The file 202 is moved to a compilation location in a step 210 where a service pulls the file 202 from the FIFO queue, opens a compiler, and submits the file 202 for compilation. The file 202 is then compiled in a step 212 together with the number of system source files 120.

If the file 202 is found to have errors, or bugs, the compiler generates a report. The compiled file and the report are stored in the device support database 116 in a step 214. The compiled file and the report are transmitted to the developer using the communication channel 106 in a step 216. The developer receives the compiled file and the report as the debug file 128 shown in FIG.1 together with the associated report. The compiled file and the report are represented in FIG. 2 by a file 218. The developer can debug the algorithm in the debug file 128 using the debugger 130 shown in FIG. 1.

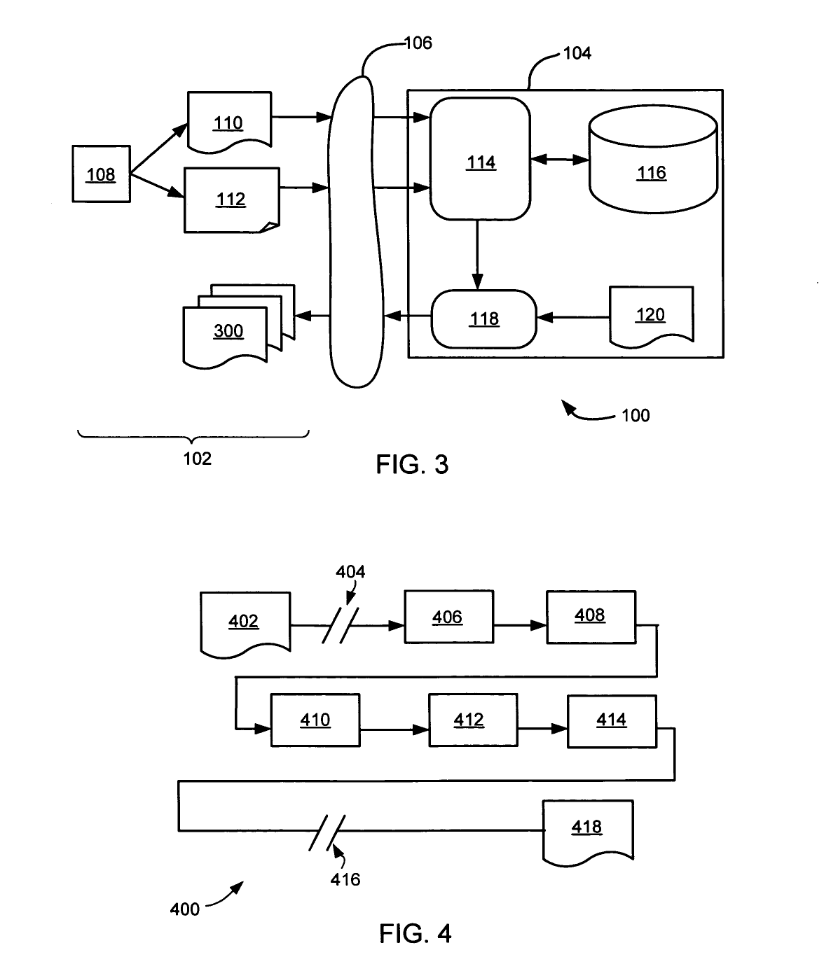

Referring now to FIG. 3, therein is shown the development system 100 shown in FIG. 1 in a beta generation mode. If the file 202 shown in FIG. 2 is approved in the support environment 104, the development system 100 generates a number of beta files 300 that are transmitted to the developer environment 102 through the communication channel 106. The beta files 300 are then used in the developer environment 102 to program the device in question using the approved algorithm.

Referring now to FIG. 4 therein is shown flow diagram of a method 400 of using the development system 100 shown in FIG. 1 in the beta generation mode after debugging. The developer creates a debugged algorithm represented in a file 402. The file 402 is transmitted in a step 404 using the communication channel 106 shown in FIG. 1. The file is received using the development interface 114 shown in FIG. 1 in a step 406.

The file 402 is temporarily stored in a queue constructed, for example, as a first in first out (FIFO) queue, in a step 408. The file 402 is moved to a compilation location in a step 410 where a service pulls the file 402 from the FIFO queue, opens a compilation and encryption encoder, and submits the file 402 for compilation and encryption. The file 402 is then compiled and encrypted in a step 412. A report is generated by the compilation and encryption encoder. The compiled and encrypted file and the report are moved to a location in a step 414. The compiled and encrypted file is transmitted to the developer using the communication channel 106 shown in FIG. 1 in a step 416. The developer receives the compiled and encrypted file and the report as the beta files 300 shown in FIG. 3. The developer can program the devices using the beta files 300 and the appropriate programming unit 126 shown in FIG. 1.

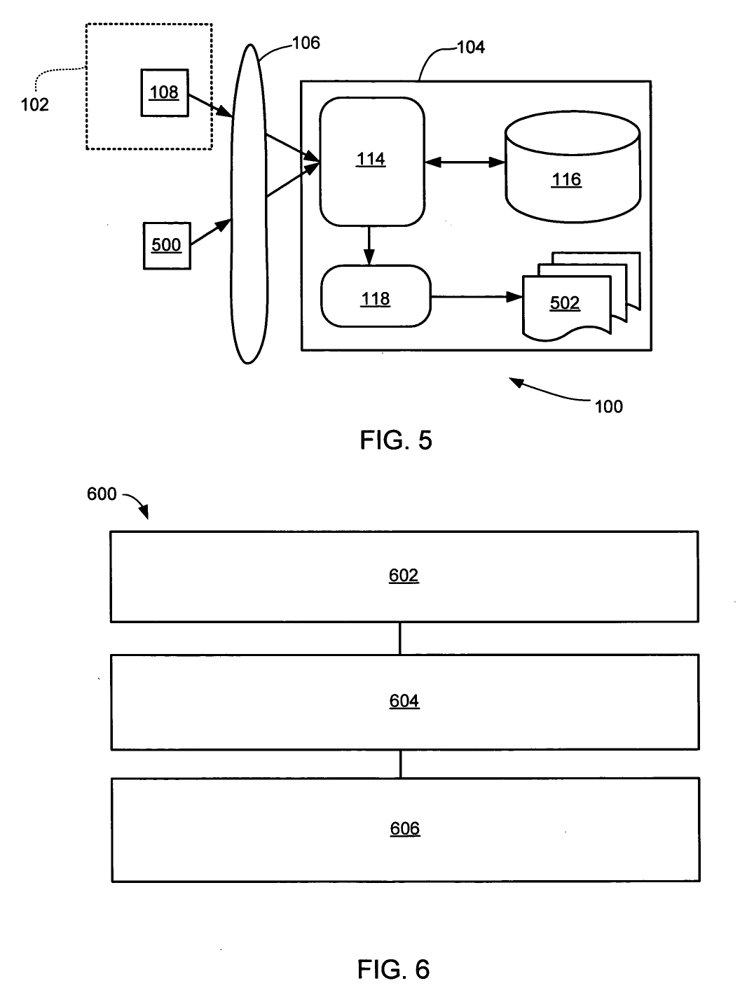

Referring now to FIG. 5, therein is shown a block diagram of the development system 100 shown in FIG. 1 in a design release mode. The development system 100 includes the developer environment 102 and the support environment 104 connected by the communication channel 106 as shown in FIG. 1. A quality assurance environment 500 also has access to the development interface 114 in the support environment 104 through the communication channel 106. The quality assurance environment 500 may be located locally at the site of the support environment 104 or at a remote location. As devices are tested and quality is assured, the tested and approved algorithm files 502 are accumulated and may be accessed by developers for future use through access to the device support database 116. The algorithm files 502 also may be copied to a recording medium, such as a compact disc, for delivery to developers.

The development system 100 may be used in a variety of ways. The developer environment 102 may be licensed by the owner of the support environment 104 to developers who create programming algorithms for devices supported by the support environment 104. The developer environment 102 may be licensed on at least one of an exclusive basis, a non-exclusive basis, a per use basis, and combinations thereof.

For example, if the developer environment 102 is licensed to a developer on an exclusive basis, the owner of the support environment 104 grants a license to the developer to use the support environment 104 for the development and debugging of programming algorithms for supported devices. The licensee would need the equipment to develop, debug, and test algorithms for the supported devices. The licensee submits algorithms or database inputs via the communication channel 106 to the support environment for compiling and linking as discussed above in reference to FIGS. 1-5. If the compilation is successful, the support environment 104 returns a compile report and programming file to the developer.

If the compilation is unsuccessful, the support environment returns the algorithm file or database file with a compiler report to the developer. The developer debugs the programming algorithm, then submits the debugged programming algorithm to the support environment for an encryption stamp and beta self install file.

The owner of the support environment 104 may agree not to distribute the developer's programming algorithm to others for a given exclusive period. The owner of the support environment 104 may own the programming algorithm and retain the programming algorithm in the device support database. The developer would have exclusive use of the programming algorithm during the given exclusive period.

The owner of the support environment would be entitled to distribute the programming algorithm to others after the exclusive period. The programming algorithm may be approved and certified for general release by the owner of the support environment 104.

The use of the development system 100 also may be licensed to developers on a non-exclusive basis. The owner of the support environment 104 would license the developer environment 102 to create programming algorithms for supported devices. Under this arrangement, the owner of the support environment would be free to distribute the programming algorithms developed by the developer to others as soon as the programming algorithm is approved by the support environment 104. The license arrangement otherwise operates the same as the exclusive license arrangement discussed above.

The use of the development system 100 also may be licensed on a per use basis. This licensing arrangement operates the same as the non-exclusive licensing arrangement except that the developer also may distribute the approved programming algorithms to others.

It has been discovered that the development system and method of the present invention provides a useful and versatile system for the development of products despite globally remote locations of the developer environment 102 and the support environment 104.

Referring now to FIG. 6, therein is shown a flow chart of a method 600 for remote support of product development in accordance with the present invention. The method 600 includes providing a development environment at a first geographic location in a block 602; providing a support environment at a second geographic location in a block 604; and providing a communication channel between the development environment and the support environment in a block 606.

Another method for remote support of product development in another embodiment of the present invention comprises: providing a developer environment at a first geographic location, the developer environment having equipment for designing and testing products; providing a support environment at a second geographic location, the support environment having alterable software changeable at the developer environment to debug and release a product; and providing a communication channel between the developer environment and the support environment to allow development in real-time of a product by design, testing, and prototyping with no human support required in the support environment.

Thus, it has been discovered that the method and apparatus of the present invention furnish important and heretofore unavailable solutions, capabilities, and functional advantages for providing device development support. The resulting process and configurations are straightforward, economical, uncomplicated, highly versatile, and effective, use conventional technologies, and are thus readily suited for remote support of product development.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

1. A method for remote support of product development comprising:
providing a developer environment at a first geographic location;
providing a support environment at a second geographic location; and
providing a communication channel between the developer environment and the support environment.

2. The method for remote support of product development as claimed in claim 1, wherein:
providing a communication channel provides communication via the Internet.

3. The method for remote support of product development as claimed in claim 1, wherein:
providing a developer environment licenses the developer environment on at least one of an exclusive basis, non-exclusive basis, per use basis, and combinations thereof.

4. The method for remote support of product development as claimed in claim 1 wherein:
product development comprises development of a programming algorithm for an electronic device;
providing a developer environment provides software and hardware used to develop and debug the programming algorithm; and
providing a support environment provides hardware and software used to approve the programming algorithm.

5. The method for remote support of product development as claimed in claim 1, wherein:
product development comprises development of a programming algorithm for an electronic device; providing a developer environment provides at least one of a personal computer, a logic analyzer, a debugger, an oscilloscope, an electronic device programmer, and combinations thereof.

6. A method for remote support of development of programmable electronic devices comprising:
providing a developer environment for the programmable electronic device at a first geographic location;
providing a support environment for the programmable electronic device at a second geographic location; and
providing a communication channel between the developer environment and the support environment.

7. The method for remote support of development of programmable electronic devices as claimed in claim 6 wherein:
providing a developer environment provides an environment for the development, debugging and programming of electronic devices using programming algorithms.

8. The method for remote support of development of programmable electronic devices as claimed in claim 6 wherein:
providing a support environment element for the programmable electronic device at a second geographic location provides an environment for at least one of compiling, encrypting, approving, storing, and distributing programming algorithms for the electronic devices, and combinations thereof.

9. The method for remote support of development of programmable electronic devices as claimed in claim 6 wherein:
providing a communication channel provides communication between the developer environment and the support environment via the Internet.

10. The method for remote support of development of
programmable electronic devices as claimed in claim 6 wherein:
providing a developer environment provides software and hardware used to develop and debug a programming algorithm for programming the electronic devices; and
providing a support environment provides hardware and software used to approve the programming algorithm.

11. A system for remote support of product development comprising:
a developer environment at a first geographic location;
a support environment at a second geographic location; and
a communication channel between the developer environment and the support environment.

12. The system for remote support of product development as claimed in claim 11, wherein:
the communication channel is the Internet.

13. The system for remote support of product development as claimed in claim 11, wherein:
the developer environment is licensed on at least one of an exclusive basis, non-exclusive basis, per use basis, and combinations thereof.

14. The system for remote support of product development as claimed in claim 11 wherein:
product development comprises development of a programming algorithm for an electronic device;
the developer environment comprises software and hardware used to develop and debug the programming algorithm; and
the support environment comprises hardware and software used to approve the programming algorithm.

15. The system for remote support of product development as claimed in claim 11, wherein:
product development comprises development of a programming algorithm for an electronic device;
the developer environment comprises at least one of a personal computer, a logic analyzer, a debugger, an oscilloscope, an electronic device programmer, and combinations thereof.

16. A system for remote support of development of programmable electronic devices comprising:
a developer environment for the programmable electronic device at a first geographic location;
a support environment for the programmable electronic device at a second geographic location; and
a communication channel between the developer environment and the support environment.

17. The system for remote support of development of programmable electronic devices as claimed in claim 16 wherein:
the developer environment at a first geographic location comprises an environment for the development, debugging and programming of electronic devices using programming algorithms.

18. The system for remote support of development of programmable electronic devices as claimed in claim 16 wherein:
the support environment element for the programmable electronic device at a second geographic location provides an environment for compiling, approving, storing, and distributing programming algorithms for the electronic devices.

19. The method for remote support of development of programmable electronic devices as claimed in claim 16 wherein:
the communication channel provides communication between the developer environment and the support environment via the Internet.

20. The system for remote support of development of programmable electronic devices as claimed in claim 16 wherein:
the developer environment provides software and hardware used to develop and debug a programming algorithm for programming the electronic devices; and
the support environment provides hardware and software used to approve the programming algorithm.

21. A method for accessing a product development support environment at a first location, comprising:
providing a developer environment at a second geographic location remote from the first location; and
providing a communication channel between the developer environment and the product development support environment.

22. The method for accessing a product development support environment at a first location as claimed in claim 21, wherein:
providing a communication channel provides communication via the Internet.

23. The method for accessing a product development support environment at a first location as claimed in claim 21, wherein:
providing a developer environment licenses the developer environment on at least one of an exclusive basis, non-exclusive basis, per use basis, and combinations thereof.

24. The method for accessing a product development support environment at a first location as claimed in claim 21, wherein:
product development comprises development of a programming algorithm for an electronic device; and
providing a developer environment provides software and hardware used to develop and debug the programming algorithm.

25. The method for accessing a product development support environment at a first location as claimed in claim 21, wherein:
product development comprises development of a programming algorithm for an electronic device;
providing a developer environment provides at least one of a personal computer, a logic analyzer, a debugger, an oscilloscope, an electronic device programmer, and combinations thereof.

26. A method for providing product development support to a remote developer environment a first location, comprising:
providing a product development support environment at a geographic location remote from the first location; and
providing a communication channel between the remote developer environment and the product development support environment.

27. The method for providing product development support to a remote developer environment a first location as claimed in claim 26, wherein:
providing a communication channel provides communication via the Internet.

28. The method for providing product development support to a remote developer environment a first location as claimed in claim 26, wherein:
providing a product development support environment licenses the remote developer environment to access the product development support environment on at least one of an exclusive basis, non-exclusive basis, per use basis, and combinations thereof.

29. The method for providing product development support to a remote developer environment a first location as claimed in claim 26, wherein:
product development comprises development of a programming algorithm for an electronic device; and
providing a product development support environment provides an environment for at least one of compiling, encrypting, approving, storing, distributing programming algorithms for the electronic devices, and combinations thereof.

30. The method for providing product development support to a remote developer environment a first location as claimed in claim 26, wherein:
product development comprises development of a programming algorithm for an electronic device;
providing a product development support environment provides an interface to the product development support environment accessible by the remote developer environment using the communication channel.

31. A system for accessing a product development support environment at a first location, comprising:
a developer environment at a second location remote from the first location; and
a communication channel between the developer environment and the product development support environment.

32. The system for accessing a product development support environment at a first location as claimed in claim 31, wherein:
the communication channel provides communication via the Internet.

33. The system for accessing a product development support environment at a first location as claimed in claim 31, wherein:
the developer environment is licensed on at least one of an exclusive basis, non-exclusive basis, per use basis, and combinations thereof.

34. The system for accessing a product development support environment at a first location as claimed in claim 31, wherein:
product development comprises development of a programming algorithm for an electronic device; and
the developer environment comprises software and hardware used to develop and debug the programming algorithm.

35. The system for accessing a product development support environment at a first location as claimed in claim 31, wherein:
product development comprises development of a programming algorithm for an electronic device;
the developer environment comprises at least one of a personal computer, a logic analyzer, a debugger, an oscilloscope, an electronic device programmer, and combinations thereof.

36. A system for providing product development support to a remote developer environment a first location, comprising:
a product development support environment at a geographic location remote from the first location; and
a communication channel between the remote developer environment and the product development support environment.

37. The system for providing product development support to a remote developer environment a first location as claimed in claim 36, wherein:
the communication channel comprises communication via the Internet.

38. The system for providing product development support to a remote developer environment a first location as claimed in claim 36, wherein:
the remote developer environment is licensed to access the product development support environment on at least one of an exclusive basis, non-exclusive basis, per use basis, and combinations thereof.

39. The system for providing product development support to a remote developer environment a first location as claimed in claim 36, wherein:
product development comprises development of a programming algorithm for an electronic device; and
the product development support environment provides an environment for at least one of compiling, encrypting, approving, storing, distributing programming algorithms for the electronic devices, and combinations thereof.

40. The system for providing product development support to a remote developer environment a first location as claimed in claim 36, wherein:
product development comprises development of a programming algorithm for an electronic device;
the product development support environment provides an interface to the product development support environment accessible by the remote developer environment using the communication channel.
